(19) United States
(12) Patent Application Publication
(10) Pub. No.: US 2008/0296805 A1
(43) Pub. Date: Dec. 4, 2008

(54) Hot Runner Melt Pre-Compression

(75) Inventors: Tiemo Dietmar BRAND, Toronto (CA); Nenad MILJKOVIC, Mississauga (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/755,862

(22) Filed: May 31, 2007

(51) Int. Cl. B28B 3/06

(52) U.S. Cl. 264/297.2; 425/190

(57) ABSTRACT

Disclosed, amongst other things, is: an injection molding runner system, an injection molding method for operation of a runner system, and an injection molding machine amongst other things. The runner system includes a geometrically unbalanced melt distribution network and a means for pre-pressurizing of the molding material within the melt distribution network.

### TECHNICAL FIELD

The present invention generally relates to, but is not limited to, molding systems, and more specifically the present invention relates to, but is not limited to, an injection molding runner system, an injection molding method for operation of a runner system, and an injection molding machine, amongst other things.

### BACKGROUND

Molding is a process by virtue of which a molded article can be formed from molding material by using a molding system. Various molded articles can be formed by using the molding process, such as an injection molding process. One example of a molded article that can be formed, for example, from polyethelene terephalate material is a preform that is capable of being subsequently blown into a beverage container, such as, a bottle and the like.

As an illustration, a typical injection molding method with PET material involves heating the PET material to a desired state and thereafter injecting, under pressure, the so-melted PET material through a runner system and into molding cavities defined in an injection mold. The so-injected PET material is then cooled to a temperature sufficient to enable ejection of the so-formed molded article from the mold.

United States Patent Published Application 2006/0108713 (Inventor: NIEWELS, Joachim, Published: 25 May 2006) describes a method and apparatus for improving the quality of molded parts with a novel injection nozzle valve structure. The valve structure includes a valve member that is movable between a fully retracted position where a gate to the molding cavity is fully open to a fully forward position where the gate is fully closed and into an intermediate position where the gate remains closed but the valve member is displaced from the gate so heat transfer through the valve member and into the gate region is minimized. Further, a distal end of valve member may be positioned in the intermediate position within a heated nozzle tip of the injection nozzle for a pre-heating thereof.

U.S. Pat. No. 6,194,041 (Inventor: MCHENRY, Robert J., Published: 27 Feb. 2001) describes an co-injection molding apparatus that includes a balanced melt distribution network and a means for pressurizing a polymer stream to produce a pressurized reservoir of polymer in the nozzle passageway between the flow directing means and the orifice, whereby, when the valve means is moved to unblock the orifice, the start of flow of the polymer through the orifice is prompt and substantially uniform around the circumference of the orifice.

### SUMMARY

According to a first broad aspect of the present invention, there is provided an injection molding method for operation of a runner system having a geometrically unbalanced melt distribution network controllably fluidly connecting an injection mold to a source of molding material. The injection molding method including pre-compressing the molding material within the geometrically unbalanced melt distribution network prior to an opening of the fluid connection with the injection mold to store potential energy in the molding material.

According to a second broad aspect of the present invention, there is provided an injection molding runner system to fluidly connect an injection mold to a source of molding material. The runner system including a geometrically unbalanced melt distribution network for controllably fluidly connecting an injection mold to a source of molding material, a controller, and a controller readable medium operatively coupled to the controller, and embodying one or more instructions executable by the controller for performing the steps of the injection molding method of the first broad aspect of the present invention.

According to a third broad aspect of the present invention, there is provided an injection molding runner system to fluidly connect an injection mold to a source of molding material. The runner system including a geometrically unbalanced melt distribution means for controllably fluidly connecting an injection mold to a source of molding material, and a pre-compression means for pre-compressing the molding material within the geometrically unbalanced melt distribution means prior to an opening of the fluid connection with the injection mold to store potential energy in the molding material.

According to a fourth broad aspect of the present invention, there is provided an injection molding runner system that includes a melt distribution network defining at least two gates. The injection molding runner system including a means for distributing a melt along a first melt flow length and a second melt flow length being, the first and second melt flow lengths being of unequal length, and a means for pre-compressing the melt along the first melt flow length and the second melt flow length prior to opening at least one of the at least two gates.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1 is a perspective view of a partially assembled runner system according to a non-limiting embodiment of the present invention;

FIG. 2 is a schematic representation of a non-limiting embodiment of a geometrically balanced melt distribution network for use within the runner system of FIG. 1;

FIG. 3 is a schematic representation of a further non-limiting embodiment of a geometrically unbalanced melt distribution network for use within the runner system of FIG. 1;

FIG. 4 is a sectional view through a non-limiting embodiment of an injection nozzle and a valve structure of the runner system of FIG. 1 taken along the section line A-A with the valve structure in a first blocking configuration;

FIG. 5 is a sectional view of the non-limiting embodiment of an injection nozzle and the valve structure of the FIG. 4 with the valve structure in an open configuration;

FIG. 6 is a sectional view of the non-limiting embodiment of an injection nozzle and the valve structure of the FIG. 4 with the valve structure in a second blocking configuration;

FIG. 7 is a graphical representation of molding material pressure profiles that contrast a typical injection molding method with that of a non-limiting embodiment of the present invention.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF THE EXEMPLARY EMBODIMENTS

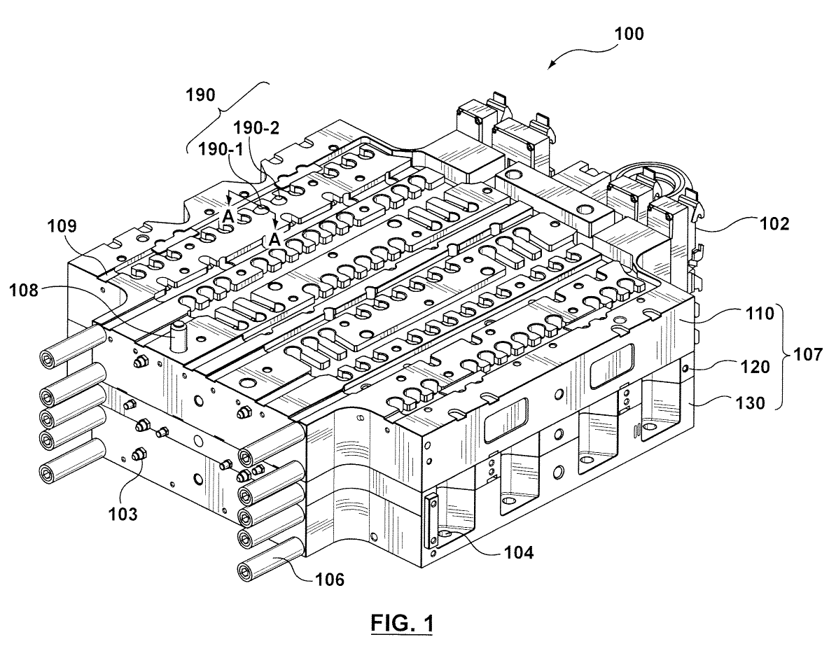

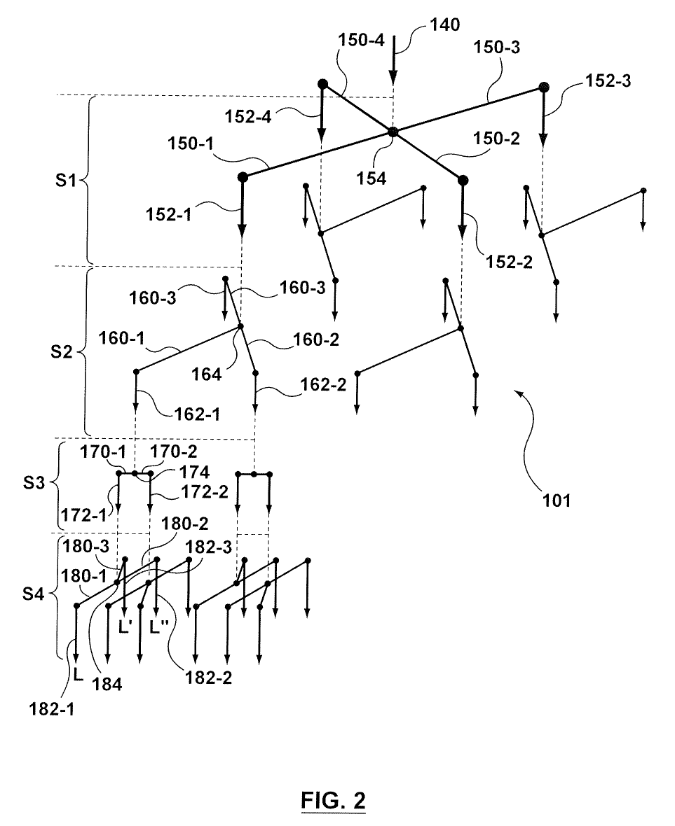

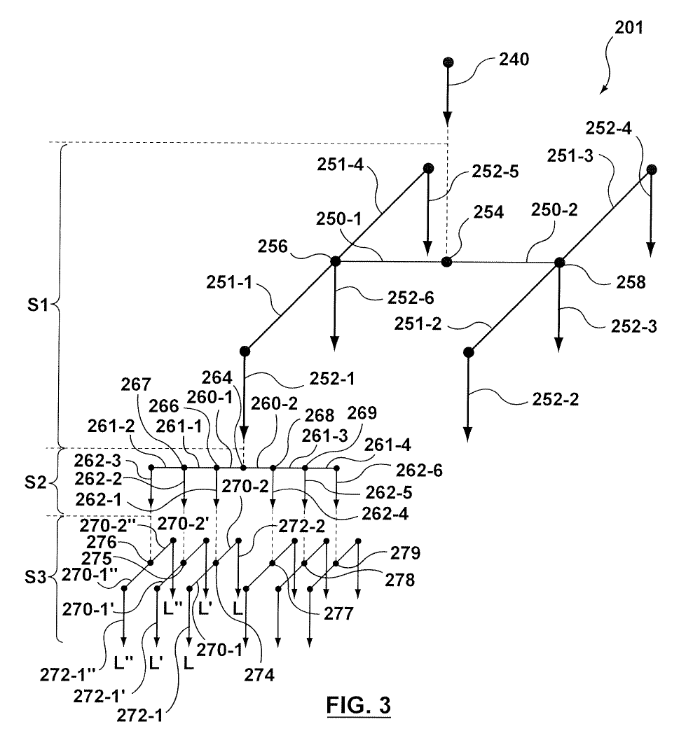

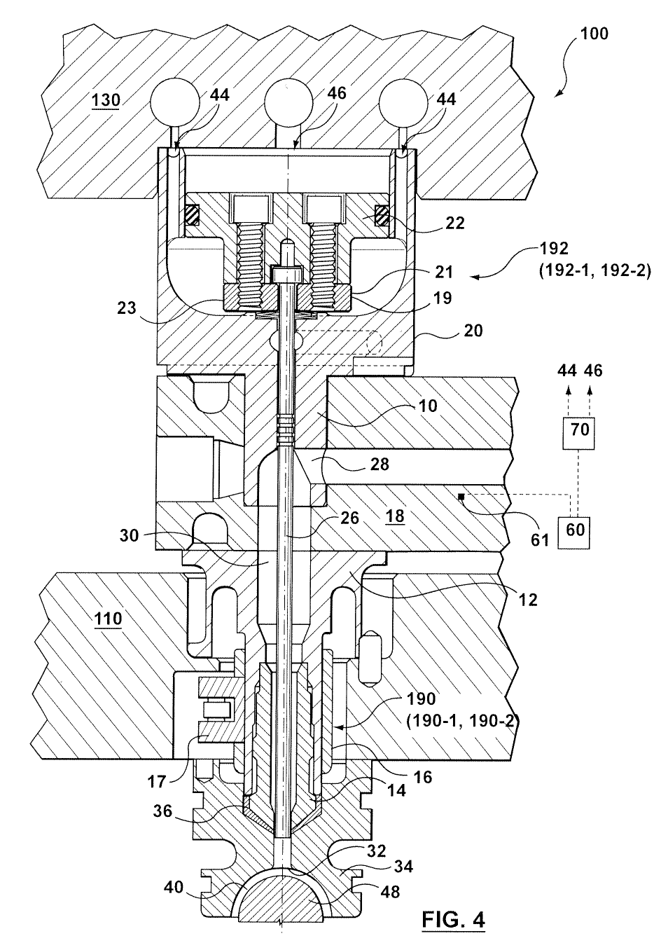

FIG. 1 shows a partially assembled runner system 100 according to a first non-limiting embodiment of the present invention for use in an injection molding system (not shown). The runner system 100 is configured to fluidly connect an injection mold (not shown) with a source of molding material (not shown). The source of molding material may include, for example, an extruder, a single stage or two-stage injection unit as is known to those skilled in the art of injection molding. The runner system 100 is typical of an injection molding hot runner insofar as it includes a base 107 for housing an arrangement of melt conduits (commonly known as manifolds) which can be heated and that are arranged to define a melt distribution network 101, 201 (FIGS. 2 and 3) for distributing the molding material from a sprue (not shown) to seventy-two injection nozzles 190. A representative first injection nozzle 190-1 and a second injection nozzle 190-2 of the seventy-two injection nozzles 190 are identified in FIG. 1. However, in alternative non-limiting embodiments (not shown), the runner system 100 may include, for example, cold runners, insulated runners, and the like, and any number of injection nozzles. The runner system 100 includes other common features that will be familiar to those skilled in the art of injection molding, and hence not described herein in any detail. One such common feature is a set of electrical connectors 102 for connecting the runner system 100 to an electrical power source (not shown) and a controller (not shown). Likewise, a set of mounting structures 104 for connecting the runner system 100 to a platen (not shown) of the injection molding system. A set of mold feet 106 are arranged on the bottom of the base 107 upon which the runner system 100 may rest when not arranged in the injection molding machine. An alignment structure 108 for aligning the runner system 100 with the injection mold (not shown). A further arrangement of fittings 103 are provided on the base 107 for connecting the runner system 100 to a pneumatic control structure (not shown). The base 107 may includes a stacked arrangement of plates including a main manifold plate 110, a cross manifold plate 120, and a backing plate 130. Arranged between the plates 110, 120, 130 are a stacked arrangement of the manifolds (not shown) that define the melt distribution network 101, 201 (FIGS. 2 and 3). Lastly, a set of grooves 109 are provided on a face of the main manifold plate 110 for running wiring (not shown) from heaters 14 (FIGS. 4, 5, and 6) and the like from the injection nozzles 190 to the connectors 102.

FIG. 2 shows the melt distribution network 101 according to a first non-limiting embodiment of the present invention. The melt distribution network 101 includes a branched array of interconnected runners extending from a single sprue runner 140 that first divides by four at a first level S1, into twelve at the second level S2, into twenty-four at a third level S3, and to seventy-two by the fourth level S4. Accordingly, the melt distribution network 101 is configured to divide the melt flow seventy-two times to provide molding material to the seventy-two injection nozzles 190 of the runner system 100. The melt distribution network 101 is characterized in that a melt flow length L measured between the sprue runner 140 and each of the injection nozzles 190 are of substantially equal length. As is commonly known, an equal melt flow length to each of the injection nozzles 190 provides for a geometrically balanced melt distribution network 101 that tends to inherently balance a flow of the molding material to each of the injection nozzles 190 whereby substantially coincident filling of all of the molding cavities is promoted.

The runners of the first level S1 include four first radial runners 150-1, 150-2, 150-3, and 150-4 of substantially equal length that are arranged in a cross-like arrangement radiating from a melt split junction 154 with the sprue runner 140. A distal end of each of the first radial runners 150-1, 150-2, 150-3, and 150-4 forms a connection with corresponding one of four first drop runners 152-1, 152-2, 152-3, 152-4 of substantially equal length that are arranged to connect with the runners of the second level S2 at a melt split junction 164. For sake of brevity, the description of the second level S2 will be limited to the runners extending from the first drop nozzle 152-1 as the same runner arrangement will be repeated in respect of each of the remaining drop nozzles 152-2, 152-3, and 152-4, respectively.

The runners of the second level S2 include three second radial runners 160-1, 160-2, and 160-3 that are of substantially equal length and arranged in a ‘Y’ arrangement radiating from the melt split junction 164 with the first drop runner 152-1. A distal end of each of the second radial runners 160-1, 160-2, and 160-3 forms a connection with corresponding one of three second drop runners 162-1, 162-2, and 162-3 of substantially equal length and that are arranged to connect with the runners of the third level S3 at a melt split junction 174. Again for sake of brevity, the description of the third level S3 will be limited to the runners extending from the second drop nozzle 162-1 as the same runner arrangement will be repeated in respect of each of the remaining drop nozzles 162-2, and 162-3, respectively.

The runners of the third level S3 include two third radial runners 170-1, and 170-2 of substantially equal length and that are arranged in a line radiating from the melt split junction 174 with the second drop runner 162-1. A distal end of each of the third radial runners 170-1, and 170-2 forms a connection with corresponding one of two third drop runners 172-1, and 172-2 of substantially equal length and that are arranged to connect with the runners of the fourth level S4 at a melt split junction 184. Again for sake of brevity, the description of the fourth level S4 will be limited to the runners extending from the third drop nozzle 172-1 as the same runner arrangement will be repeated in respect of the remaining drop nozzle 172-2.

The runners of the fourth level S4 include three fourth radial runners 180-1, 180-2 and 180-3 of substantially equal length and that are arranged in a line radiating from the melt split junction 184 with the third drop runner 172-1. A distal end of each of the third radial runners 180-1, 180-2, and 180-3 form a connection with corresponding one of three fourth drop runners 182-1, 182-2, and 182-3 of substantially equal length and that are arranged to connect with the injection nozzles 190 (FIG. 1).

Accordingly, the melt distribution network 101 defines an equal melt flow length L to each of the seventy-two injection nozzles 190 to provide the geometrically balanced melt distribution network 101 that tends to inherently balance a flow of the molding material to each of the injection nozzles 190 whereby coincident filling of all of the molding cavities is promoted.

Even with the geometric balanced melt distribution network 101 it has been noted that some melt flow unbalance between injection nozzles remains. For example, testing elucidated a time delay upwards of two seconds between a first and a last of the molding cavities to fill. The delay lengthens the overall time required to perform a complete molding cycle.

The improvements to the runner system 100 and injection molding process that follow provide for surprising reductions in the time required to fill the injection mold, and hence a reduction in the time required to perform a complete molding cycle. In addition, the improvements may mitigate the filling unbalance between the molding cavities.

FIG. 4 shows the injection nozzle 190 including nozzle housing 12 and nozzle tip 14 secured thereto. The injection nozzle 190 is located in main manifold plate 110 and supporting manifold 18 (i.e. defines at least one of the runners of the melt distribution network 101). Mounted in manifold 18 is valve bushing 20 that contains pneumatic piston 22 that is attached to valve member 26. The valve bushing 20, piston 22, and the valve member cooperate to provide a valve structure 192. The first injection nozzle 190-1, a second injection nozzle 190-2, and likewise a first valve structure 192-1, and a second valve structure 192-2 of the seventy-two injection nozzles 190 and related valve structures 192 are also identified.

A melt channel 28, corresponding with one of the fourth radial runners 180-1, 180-2, 180-3 of the melt distribution network 101, in manifold 18 is connected through extension 10 of valve bushing 20 to central melt channel 30, corresponding with one of the fourth drop runners 182-1, 182-2, 182-3 of the melt distribution network 101, in nozzle housing 12 which in turn leads to injection orifice or gate 32 in gate insert 34 (not shown in FIG. 1). Insulator 36 occupies the space between nozzle tip 14 and gate insert 34.

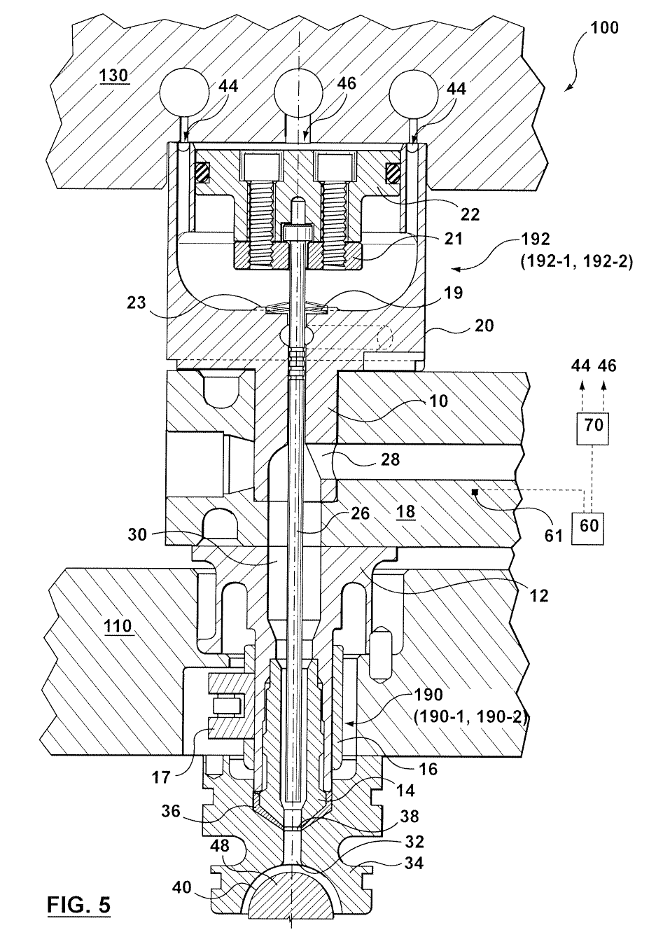

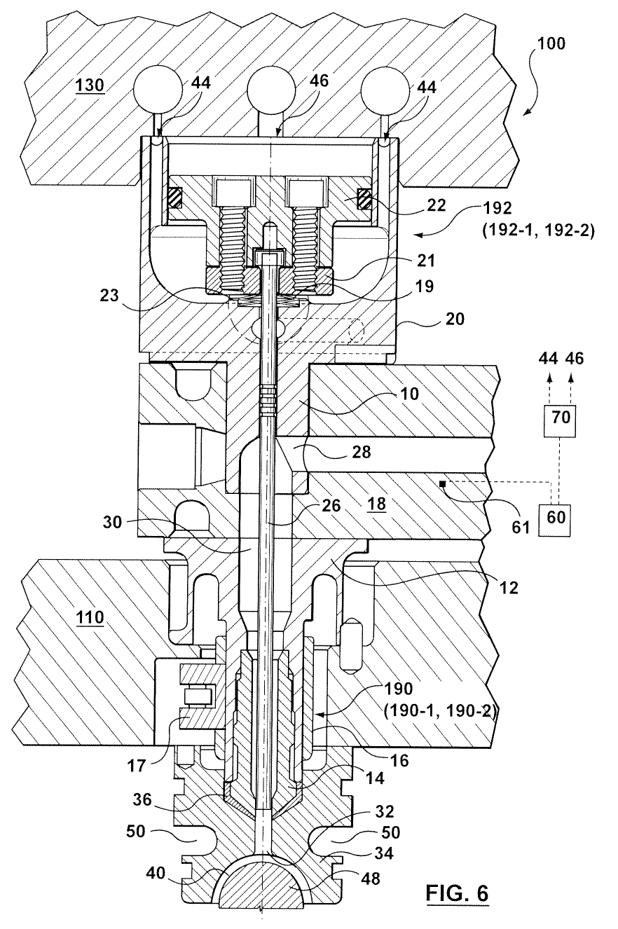

Pneumatic piston 22 is operated by air pressure through air lines 44 and 46 from a source of compressed air (not shown) such that, by directing compressed air appropriately, valve member 26 can be moved to one of two positions. FIG. 4 shows valve member 26 in a closed position (i.e. first blocking configuration) in cooperation with a melt channel opening 38 to substantially prevent flow of the molding material through the injection nozzles 190 and into the molding cavity 40. The valve member 26 is moved to the closed position by exhausting air from line 44 to permit piston 22 to move forward and introducing compressed air into line 46 to move piston 22 forward. In FIG. 5, piston 22 is fully retracted by compressed air flowing through line 44 causing the piston to move upward thereby fully retracting valve member 26 within nozzle housing 12 (i.e. open configuration) and permitting resin to flow into the mold cavity 40 via the melt channel opening 38. FIG. 6 shows valve member 26 in an intermediate position (i.e. second blocking configuration) to substantially prevent flow of the molding material through the injection nozzles 190 and that brings the valve member 26 out of contact with a cooled gate insert 34 of the injection mold. The valve member 26 is moved to the intermediate position shown in FIG. 6 by spring 19 that operates to retract piston 22 a limited amount when the pressure on either side of piston 22 is equalized. Spring 19 is compressed when piston 22 moves forward to close the valve opening as shown in FIG. 4. When the valve member 26 is arranged in the intermediate position cooling channels 50 in gate insert 34 continue to cause resin in the mold cavity 40 and the melt channel opening 38 to solidify prior to opening the mold but does not cool the end of valve member 26 because it has been retracted into the warm and heated nozzle tip 14. In addition, the positioning of the valve member in the intermediate position (i.e. second blocking configuration) has the additional technical effect of pre-heating the valve member to substantially prevent the formation of a weepage of molding material in a crystalline state adjacent an outer surface thereof that may otherwise contribute to a defective molded article. In accordance with this non-limiting embodiment the retraction to the intermediate position may be 2 millimeters. Of course, those skilled in the art would understand that there are other means to move the valve member to the intermediate position such as, for example, the double acting piston assembly such as that described in the commonly assigned United States Patent Published Application 2006/0108713.

FIG. 3 shows the melt distribution network 201 according to a further non-limiting embodiment of the present invention. The melt distribution network 201 includes a branched array of interconnected runners extending from a single sprue runner 240 that first divides by six at a first level S1, into thirty-six at the second level S2, and to seventy-two by the third level S3. Accordingly, the melt distribution network 201 is configured to divide the melt flow seventy-two times to provide molding material to the seventy-two injection nozzles 190 of the runner system 100. The melt distribution network 201 is characterized in that a melt flow length L, L′, L″ measured between the sprue runner 240 and the seventy-two injection nozzles 190 are not all the same. The unequal melt flow length to each of the injection nozzles 190 provides for a geometrically unbalanced melt distribution network 201 that does not inherently balance a flow of the molding material to each of the injection nozzles 190. A technical effect of the geometrically unbalanced melt distribution network 201 in combination with melt pre-pressurization may include a simplified runner structure that may be more economically manufactured relative to the geometrically balanced melt distribution network 101 and yet have improved melt flow balance to the injection nozzles.

The runners of the first level S1 include two first radial runners 250-1 and 250-2 of substantially equal length that radiate in opposite directions from a melt split junction 254 with the sprue runner 240. A distal end of the first radial runner 250-1 forms another melt split junction 256 with a first drop runner 252-6 and a corresponding pair of first span runners 251-1 and 251-4 of substantially equal length that span between the melt split junction 256 and each of additional first drop runners 252-1, and 252-5, respectively. The first span runners 251-1 and 251-4 are of substantially equal length and radiate in opposite directions from the melt split junction 256 and generally perpendicular to the first radial runner 250-1. A distal end of each of the span runners 251-1 and 251-4 forms a connection with corresponding one of the additional first drop runners 252-1 and 252-6, respectively. Likewise, a distal end of the first radial runner 250-2 forms another melt split junction 258 with a first drop runner 252-3 and a corresponding pair of first span runners 251-2 and 251-3 of substantially equal length that span between the melt split junction 258 and each of additional first drop runners 252-2, and 252-4, respectively. The first span runners 251-2 and 251-3 are of substantially equal length (as well as being equal in length to the first span runners 251-1 and 251-4) and radiate in opposite directions from the melt split junction 258 and generally perpendicular to the first radial runner 250-2. A distal end of each of the span runners 251-2 and 251-3 forms a connection with corresponding one of the additional first drop runners 252-2 and 252-4, respectively. The first drop runners 252-1, 252-2, 252-3, 252-4, 252-5, and 252-6 are of substantially equal length and are arranged to connect with the runners of the second level S2 at a melt split junction 264.

For sake of brevity, the description of the second level S2 will be limited to the runners extending from the first drop nozzle 252-1 as the same runner arrangement will be repeated in respect of each of the remaining drop nozzles 252-2, 252-3, 252-4, 252-5 and 252-6, respectively. The runners of the second level S1 include two second radial runners 260-1 and 260-2 of substantially equal length that radiate in opposite directions from the melt split junction 264 with the sprue runner 240. A distal end of the second radial runner 260-1 forms another melt split junction 266 with a second drop runner 262-1 and a second span runner 261-1 that spans between the melt split junction 266 and an additional melt split junction 267. The melt split junction 267 is formed at a junction between the second span runner 260-1, a further second drop runner 262-2, and a further second span runner 261-2 that spans between the melt split junction 267 and an additional second drop channel 262-3 at a distal end thereof. Likewise, a distal end of the second radial runner 260-2 forms another melt split junction 268 with a second drop runner 262-4 and a second span runner 261-3 that spans between the melt split junction 268 and an additional melt split junction 269. The melt split junction 269 is formed at a junction between the second span runner 260-3, a further second drop runner 262-5, and a further second span runner 261-4 that spans between the melt split junction 269 and an additional second drop channel 262-6 at a distal end thereof. The second span runners 261-1, 261-2, 261-3, and 261-4 are of substantially equal length and extend along a line with the second radial runners 260-1 and 260-2. The second drop runners 262-1, 262-2, 262-3, 262-4, 262-5, and 262-6 are of substantially equal length and are arranged to connect with the runners of the third level S3 at a melt split junctions 274, 275, 276, 277, 278, and 279, respectively.

Again for sake of brevity, the description of the third level S3 will be largely limited to the runners extending from the second drop nozzles 262-1, 262-2, and 262-3 as the same runner arrangement will be repeated in respect of the remaining drop nozzles 262-4, 262-5, and 262-6. The runners of the third level S3 include pairs of radial runners 270-1, 270-2, 270-1′, 270-2′, 270-1″, 270-2″ that are of substantially equal length and arranged in a line radiating from the melt split junctions 274, 275, 276, 277, 278, and 279, respectively. A distal end of each of the radial runners 270-1, 270-2, 270-1′, 270-2′, 270-1″, 270-2″ forms a connection with corresponding one of third drop runners 272-1, 272-2, 272-1′, 272-2′, 272-1″, 272-2″, respectively. The third drop runners 272-1, 272-2, 272-1′, 272-2′, 272-1″, 272-2″ are of substantially equal length and are arranged to connect with the injection nozzles 190 (FIG. 1).

Accordingly, the melt distribution network 201 defines a first melt flow length L from the sprue runner 240 to first injection nozzles 190-1 of the seventy-two injection nozzles 190 (FIG. 1) connected to the third drop runners 272-1, 272-2, a second melt flow length L′ from the sprue runner 240 to second injection nozzles 190-2 of the seventy-two injection nozzles 190 (FIG. 1) connected to the third drop runners 272-1′, 272-2′, and a third melt flow length L″ from the sprue runner 240 to third injection nozzles of the seventy-two injection nozzles 190 (FIG. 1) connected to the third drop runners 272-1″, 272-2″, the first, second, and third melt flow lengths L, L′, L″ are of unequal length.

Similar improvements to the geometrically unbalanced runner system 100 and injection molding process to those described before may provide for similar reductions in the time required for filling of the injection mold, and hence a reduction in the time required for performing a complete molding cycle. In addition, the improvements may mitigate the filling unbalance between the molding cavities which would make such relatively economically geometrically unbalanced runner systems 100 a more commercially attractive option.

The improvements may include structure and steps to provide for molding material pre-pressurization prior to injection of the molding material into the injection mold. Optionally, the injection molding process also includes the step of operating the valve structure similar to that of commonly assigned United States Patent Published Application 2006/0108713 (Inventor: NIEWELS, Joachim, Published: 25 May 2006), and as described hereinbefore, for a step of valve member pre-positioning prior to injection to cause a pre-heating thereof.

An injection molding method for operation of a runner system 100 in accordance with a non-limiting embodiment will now be discussed. The runner system 100 including the melt distribution network 101, 201 controllably fluidly connecting an injection mold (not shown) to a source of molding material (not shown), and a valve structure 192 disposed between the injection mold and the melt distribution network 101, 201. The valve structure 192 movable between a first blocking configuration (FIG. 4) that substantially prevents a flow of the molding material to the injection mold, a second blocking configuration (FIG. 6) that substantially prevents a flow of the molding material to the injection mold and provides for a pre-heating of the valve structure 192, at least in part, and an open configuration (FIG. 5) that permits a flow of the molding material to the injection mold. In the first blocking configuration (FIG. 4) a distal end of valve members 26 associated with each of the first and second valve structures 192-1, 192-2 are positioned in a fully forward position adjacent corresponding gates 32 defined in the injection mold. In the second blocking configuration (FIG. 6) the distal end of the valve members 26 associated with each of the first and second valve structures 192-1, 192-2 are positioned in an intermediate position within a heated nozzle tip 14 of the corresponding first and second injection nozzles 190-1, 190-2 for a pre-heating thereof. The injection molding method includes pre-compressing the molding material within the melt distribution network 101, 201 to store potential energy in the molding material while the valve structure 192 is in a blocking configuration (FIG. 4 or 6) that includes one of the first blocking configuration, the second blocking configuration, or a first portion in the first blocking configuration and a second portion in the second blocking configuration. Then, positioning the valve structure 192 from the first blocking configuration to the second blocking configuration. Also, positioning the valve structure 192 in the open configuration (FIG. 5) to permit flow of the pre-pressurized molding material to the injection mold and convert a portion of the potential energy into kinetic energy.

A technical effect of pre-heating of the distal end of the valve members 26 in the second blocking configuration may include a reduction in the formation of a weepage of molding material in a crystalline state adjacent an outer surface thereof that may otherwise contribute to a defective molded article.

The non-limiting embodiment of the runner system 100 may further include the melt distribution network 101, 201 defining a first melt flow length L to a first injection nozzle 190-1 and a second melt flow length L′ to a second injection nozzle 190-2. The valve structure 192 including a first valve structure 192-1 configured to control a flow of the molding material through the first injection nozzle 190-1 and a second valve structure 192-2 configured to control a flow of the molding material through the second injection nozzle 190-2. The melt distribution network 101, 201 may be geometrically balanced or unbalanced wherein the first and second melt flow lengths L, L′ are of equal or unequal length, respectively. With the foregoing embodiment the injection molding method may further include positioning the first and second valve structures 192-1, 192-2 in one of the first blocking configuration, the second blocking configuration, or a first portion in the first blocking configuration and a second portion in the second blocking configuration during pre-pressurizing of the melt distribution network 101, 201. Then, positioning the first and second valve structures 192-1, 192-2 from the first blocking configuration to the second blocking configuration. Then, positioning the first and second valve structures 192-1, 192-2 in the open configuration to permit flow of the pre-pressurized molding material through the first and second injection nozzles 190-1, 190-2 and convert a portion of the potential energy into kinetic energy. Then, injecting the molding material to fill molding cavities 40 associated with a respective one of the first and the second injection nozzle 190-1, 190-2 and the returning the first and second valve structures 192-1, 192-2 into the blocking configuration.

The positioning of the first and second valve structures 192-1, 192-2 into the open configuration (FIG. 5) optionally includes at a first time positioning the first valve structure 192-1 into the open configuration, and at a second time positioning the second valve structure 192-2 into the open configuration. The first and second times may be the same, or the second time may be later that the first time.

The positioning of the first and second valve structures 192-1, 192-2 into the blocking configuration (FIG. 4 or 6) optionally includes at a third time positioning the first valve structure 192-1 into the blocking configuration, and at a fourth time positioning the second valve structure 192-2 into the blocking configuration. The third and fourth times may be the same, or the fourth time may be later than the third time.

The first and the second time optionally coincide with a first feedback signal from a first transducer 61 (FIG. 4, 5, or 6) indicating that a pressure of the molding material within the melt distribution network 201 has reached a first pre-determined melt pressure value.

The injecting of the molding material optionally includes holding the molding material in the molding cavities 40 at a second pre-determined melt pressure.

The injection molding method optionally includes after the configuring of the first and second valve structures 192-1, 192-2 in the blocking configuration a cooling of the molding material in the molding cavities 40.

The injection molding method optionally includes the positioning of the first and second valve structure 192-1, 192-2 into the second blocking configuration immediately or shortly before the positioning of the first and second valve structures 192-1, 192-2 into the open configuration such that the valve member 26 is pre-heated, at least in part, at the time of opening.

The injection molding method optionally includes positioning of the first and second valve structures 192-1, 192-2 into the first blocking configuration after completion of the injecting of the molding material to fill the molding cavities 40.

An injection molding method for operation of a runner system 100 in accordance with a further non-limiting embodiment will now be discussed. The runner system 100 having the geometrically unbalanced melt distribution network 201 controllably fluidly connecting an injection mold (not shown) to a source of molding material (not shown). The injection molding method includes pre-compressing the molding material within the geometrically unbalanced melt distribution network 201 prior to an opening of the fluid connection with the injection mold to store potential energy in the molding material.

The non-limiting embodiment of the runner system 100 may include the geometrically unbalanced melt distribution network 201 defining a first melt flow length L to a first injection nozzle 190-1, a second melt flow length L′ to a second injection nozzle 190-2, wherein the first and second melt flow lengths L, L′ are of unequal length. The non-limiting embodiment of the runner system 100 may further include a first valve structure 192-1 configured to control a flow of the molding material through the first injection nozzle 190-1, and a second valve structure 192-2 configured to control a flow of the molding material through the second injection nozzle 190-2. With the foregoing embodiment the injection molding method may further include the step of positioning the first and second valve structures 192-1, 192-2 in a blocking configuration (FIG. 4 or 6) to prevent flow of the molding material through the first and second injection nozzles 190-1, 190-2 during pre-pressurizing of the melt distribution network 201. Then, positioning the first and second valve structures 192-1, 192-2 into an open configuration (FIG. 5) to permit flow of the pre-pressurized molding material through the first and second injection nozzles 190-1, 190-2 and convert a portion of the potential energy into kinetic energy. Then, injecting the molding material to fill molding cavities 40 associated with a respective one of the first and the second injection nozzle 190-1, 190-2 and the returning the first and second valve structures 192-1, 192-2 into the blocking configuration.

The positioning of the first and second valve structures 192-1, 192-2 into the open configuration (FIG. 5) optionally includes at a first time positioning the first valve structure 192-1 into the open configuration, and at a second time positioning the second valve structure 192-2 into the open configuration. The first and second times may be the same, or the second time may be later that the first time.

The positioning of the first and second valve structures 192-1, 192-2 into the blocking configuration (FIG. 4 or 6) optionally includes at a third time positioning the first valve structure 192-1 into the blocking configuration, and at a fourth time positioning the second valve structure 192-2 into the blocking configuration. The third and fourth times may be the same, or the fourth time may be later than the third time.

The first and the second time optionally coincide with a first feedback signal from a first transducer 61 (FIG. 4, 5, or 6) indicating that a pressure of the molding material within the melt distribution network 201 has reached a first pre-determined melt pressure value.

The injecting of the molding material optionally includes holding the molding material in the molding cavities 40 at a second pre-determined melt pressure.

The injection molding method optionally includes after the configuring of the first and second valve structures 192-1, 192-2 in the blocking configuration a cooling of the molding material in the molding cavities 40.

The blocking position may include a first blocking configuration (FIG. 4) wherein a distal end of valve members 26 associated with each of the first and second valve structures 192-1, 192-2 are positioned in a fully forward position adjacent corresponding gates 32 defined in the injection mold. The blocking position may also include a second blocking configuration (FIG. 6) wherein the distal end of the valve members 26 associated with each of the first and second valve structures 192-1, 192-2 are positioned in an intermediate position within a heated nozzle tip 14 of the corresponding first and second injection nozzles 190-1, 190-2 for a pre-heating thereof. The injection molding method optionally includes positioning of the first and second valve structures 192-1, 192-2 into the second blocking configuration before positioning the first and second valve structures 192-1, 192-2 into the open configuration for performing the pre-heating of the distal end of the valve members 26. The positioning of the first and second valve structure 192-1, 192-2 into the second blocking configuration may be performed immediately before the positioning of the first and second valve structures 192-1, 192-2 into the open configuration. The injection molding method optionally includes positioning of the first and second valve structures 192-1, 192-2 into the first blocking configuration after completion of the injecting of the molding material to fill the molding cavities 40.

A technical effect of pre-heating of the distal end of the valve members 26 in the second blocking configuration may include a reduction in the formation of a weepage of molding material in a crystalline state adjacent an outer surface thereof that may otherwise contribute to a defective molded article.

The pre-pressurization of the melt distribution network may be performed with the first and second valve structures 192-1, 192-2 positioned in the first blocking configuration, the second blocking configuration, or a first portion in the first blocking configuration and a second portion in the second blocking configuration.

The positioning of the first and second valve structures 192-1, 192-2 into the second blocking configuration optionally includes at a fifth time positioning the first valve structure 192-1 into the second blocking configuration, and at a sixth time positioning the second valve structure 192-2 into the second blocking configuration. The fifth and sixth times may be the same, or optionally the sixth time is later than the fifth time.

A controller 60 (FIG. 4, 5, or 6) or processor may be used to implement the injection molding method, as described above. The controller 60 may, for example, control a pneumatic control structure 70 that controls the air flow to the lines 44, 46 that operate the valve structures 192. The controller 60 or processor may, for example, include one or more general-purpose computers, Application Specific Integrated Circuits, Digital Signal Processors, gate arrays, analog circuits, dedicated digital and/or analog processors, hard-wired circuits, etc., may receive input from the feedback signals described herein. Instructions for controlling the one or more of such controllers 60 or processors may be stored in any desirable computer-readable medium and/or data structure, such floppy diskettes, hard drives, CD-ROMs, RAMs, EEPROMs, magnetic media, optical media, magneto-optical media, etc.

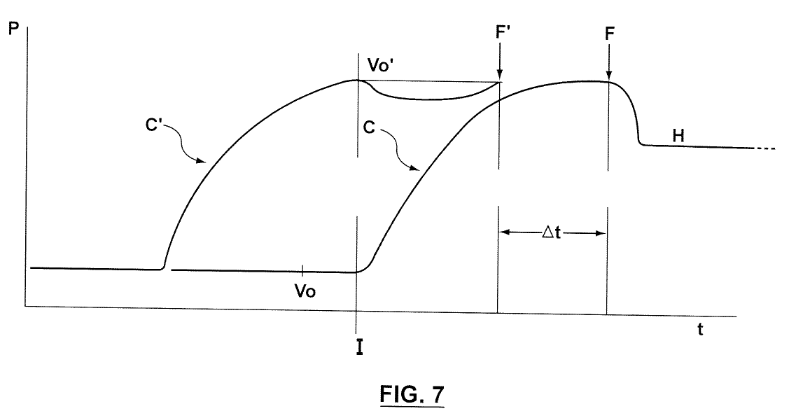

To illustrate the technical effect of reduced injection mold filling time, the molding material pressure profiles representative of a typical injection molding method (i.e. without pre-pressurization or valve member pre-positioning) contrasted with that of a non-limiting embodiment of the present invention (i.e. with pre-pressurization) are shown in FIG. 7. The pressure profile C of the typical injection molding method includes an initial near constant pressure curve that extends past a point Vo, where the valve structures 192 of the runner system 100 opens and a pressurization within the melt distribution network 101, 201 begins, and after a time dwell to a point I, where the melt pressure finally starts to rise in the injection nozzles 190 of the runner system 100. Thereafter, the molding material pressure rises to a plateau at point F that coincides with the molding cavity being completely filled. Thereafter, the pressure is held, for a time, along the curve H to pack out the molded article. In contrast, the injection molding method molding cavity pressure profile C′ according to the non-limiting embodiment shows the shift in the pressurization of the melt distribution network 101, 201 before the point Vo′ whereby the point I′ at which the injection mold begins to fill now coincides with Vo′. Accordingly, the point F′ where the injection mold is completely filled also shifts left to an earlier point in time. The reduction in the time required to fill the mold is shown between F and F′ as Δt. Thereafter, the pressure is held, for a time, along a similar curve (not shown) to H to pack out the molded article.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. An injection molding method for operation of a runner system having a geometrically unbalanced melt distribution network controllably fluidly connecting an injection mold to a source of molding material, the injection molding method comprising:
pre-compressing the molding material within the geometrically unbalanced melt distribution network prior to an opening of the fluid connection with the injection mold to store potential energy in the molding material.

2. The injection molding method according to claim 2, wherein:
the geometrically unbalanced melt distribution network defines:
a first melt flow length to a first injection nozzle;
a second melt flow length to a second injection nozzle;
the first and second melt flow lengths are of unequal length;
the runner system further including:
a first valve structure configured to control a flow of the molding material through the first injection nozzle;
a second valve structure configured to control a flow of the molding material through the second injection nozzle;
wherein the injection molding method further comprises:
positioning the first and second valve structures in a blocking configuration to prevent flow of the molding material through the first and second injection nozzles during pre-pressurizing of the melt distribution network;
positioning the first and second valve structures into an open configuration to permit flow of the pre-pressurized molding material through the first and second injection nozzles and convert a portion of the potential energy into kinetic energy;
injecting the molding material to fill molding cavities associated with a respective one of the first and the second injection nozzle; and
positioning the first and second valve structures into the blocking configuration.

3. The injection molding method according to claim 2, wherein:
the positioning of the first and second valve structures into the open configuration further includes:
at a first time positioning the first valve structure into the open configuration;
at a second time positioning the second valve structure into the open configuration;
wherein the first and second times are the same.

4. The injection molding method according to claim 2, wherein:
the positioning of the first and second valve structures into the open configuration further includes:
at a first time positioning the first valve structure into the open configuration;
at a second time positioning the second valve structure into the open configuration;
the second time is later that the first time.

5. The injection molding method according to claim 2, wherein:
the positioning of the first and second valve structures into the blocking configuration further includes:
at a third time positioning the first valve structure into the blocking configuration;
at a fourth time positioning the second valve structure into the blocking configuration;
the third and fourth times are the same.

6. The injection molding method according to claim 2, wherein:
the positioning of the first and second valve structures into the blocking configuration further includes:
at a third time positioning the first valve structure into the blocking configuration;
at a fourth time positioning the second valve structure into the blocking configuration;
the fourth time is later than the third time.

7. The injection molding method according to one of claims 3 or 4, wherein:
the first and the second time coincide with a first feedback signal from a first transducer indicating that a pressure of the molding material within the melt distribution network has reached a first pre-determined melt pressure value.

8. The injection molding method according to claim 2, wherein the injecting of the molding material further includes holding the molding material in the molding cavities at a second pre-determined melt pressure.

9. The injection molding method according to claim 2, further including:
cooling the molding material in the molding cavities.

10. The injection molding method according to claim 2, wherein the blocking position includes:
a first blocking configuration wherein a distal end of valve members associated with each of the first and second valve structures are positioned in a fully forward position adjacent corresponding gates 32 defined in the injection mold;
a second blocking configuration wherein the distal end of the valve members associated with each of the first and second valve structures are positioned in an intermediate position within a heated nozzle tip of the corresponding first and second injection nozzles for a pre-heating thereof;
the injection molding method further including:
positioning of the first and second valve structures into the second blocking configuration is performed before positioning the first and second valve structures into the open configuration.

11. The injection molding method according to claim 10, wherein:
the positioning of the first and second valve structure into the second blocking configuration is performed immediately before the positioning of the first and second valve structures into the open configuration.

12. The injection molding method according to claim 10, further including:
positioning of the first and second valve structures into the first blocking configuration is performed after completion of the injecting of the molding material to fill the molding cavities.

13. The injection molding method according to claim 10, wherein:
the positioning of the first and second valve structures into the second blocking configuration further includes:
at a fifth time positioning the first valve structure into the second blocking configuration;
at a sixth time positioning the second valve structure into the second blocking configuration;
the fifth and sixth times are the same.

14. The injection molding method according to claim 10, wherein:
the positioning of the first and second valve structures into the second blocking configuration further includes:
at a fifth time positioning the first valve structure into the second blocking configuration;
at a sixth time positioning the second valve structure into the second blocking configuration;
the sixth time is later than the fifth time.

15. The injection molding method according to claim 10, wherein:
the pre-pressurization of the melt distribution network performed with the first and second valve structures positioned in one of:
the first blocking configuration;
the second blocking configuration; or
a first portion in the first blocking configuration and a second portion in the second blocking configuration.

16. An injection molding runner system to fluidly connect an injection mold to a source of molding material, the runner system comprising:
a geometrically unbalanced melt distribution network for controllably fluidly connecting an injection mold to a source of molding material;
a valve structure disposed between the injection mold and the geometrically unbalanced melt distribution network for controlling a flow of the molding material to the injection mold;
a controller; and
a controller readable medium operatively coupled to the controller, and embodying one or more instructions executable by the controller for performing the steps of the injection molding method of any one of claims 1 to 15.

17. An injection molding runner system to fluidly connect an injection mold to a source of molding material, the runner system comprising:
a geometrically unbalanced melt distribution means for controllably fluidly connecting an injection mold to a source of molding material;
a melt pre-compression means for pre-compressing the molding material within the geometrically unbalanced melt distribution means prior to an opening of the fluid connection with the injection mold to store potential energy in the molding material.

18. The injection molding runner system according to claim 17, wherein:
the geometrically unbalance melt distribution means includes a melt distribution network that defines:
a first melt flow length to a first injection nozzle;
a second melt flow length to a second injection nozzle;
the first and second melt flow lengths are of unequal length;
the melt pre-compression means for pre-compressing the molding material within the melt distribution network includes:
a first valve structure configured to control a flow of the molding material through the first injection nozzle;
a second valve structure configured to control a flow of the molding material through the second injection nozzle.

19. The injection molding runner system according to claim 18, wherein:
the first valve structure configured for positioning into the open configuration at a first time;
the second valve structure configured for positioning into the open configuration at a second time;
wherein the first and second times are the same.

20. The injection molding runner system according to claim 18, wherein:
the first valve structure configured for positioning into the open configuration at a first time;
the second valve structure configured for positioning into the open configuration at a second time;
wherein the second time is later that the first time.

21. The injection molding runner system according to claim 18, wherein:
the first valve structure configured for positioning into the blocking configuration at a third time;
the second valve structure configured for positioning into the blocking configuration at a fourth time;
the third and fourth times are the same.

22. The injection molding runner system according to claim 18, wherein:
the first valve structure configured for positioning into the blocking configuration at a third time;
the second valve structure configured for positioning into the blocking configuration at a fourth time;
the fourth time is later than the third time.

23. The injection molding runner system according to one of claims 19 or 20, further including:
a first transducer configured to indicate a pressure of the molding material within the melt distribution network wherein the first and the second time coincide with a first feedback signal from the first transducer.

24. The injection molding runner system according to claim 18, wherein:
the first and second valve structures are configured for positioning in the blocking configuration that includes:
a first blocking configuration wherein a distal end of valve members associated with each of the first and second valve structures are positioned in a fully forward configuration adjacent corresponding gates 32 defined in the injection mold;
a second blocking configuration wherein the distal end of the valve members associated with each of the first and second valve structures are positioned in an intermediate position within a heated nozzle tip of the corresponding first and second injection nozzles for a pre-heating thereof.

25. The injection molding runner system according to claim 24, wherein:
the first valve structure configured for positioning into the second blocking configuration at a fifth time;
the second valve structure configured for positioning into the second blocking configuration at a sixth time;
the fifth and sixth times are the same.

26. The injection molding runner system according to claim 24, wherein:
the first valve structure configured for positioning into the second blocking configuration at a fifth time;
the second valve structure configured for positioning into the second blocking configuration at a sixth time;
the sixth time is later than the fifth time.

27. An injection molding runner system that includes a melt distribution network defining at least two gates, comprising:
a means for distributing a melt along a first melt flow length and a second melt flow length being, the first and second melt flow lengths being of unequal length;
a means for pre-compressing the melt along the first melt flow length and the second melt flow length prior to opening at least one of the at least two gates.

28. An injection molding machine including the injection molding runner system of any one of claims 16 to 27.
